(19) United States
(12) Patent Application Publication
(10) Pub. No.: US 2025/0280331 A1
(43) Pub. Date: Sep. 4, 2025

(54) METHODS AND APPARATUSES FOR CROSS-LAYER OPTIMIZATION IN WIRELESS COMMUNICATIONS

(71) Applicant: InterDigital Patent Holdings, Inc., Wilmington, DE (US)

(72) Inventor: Renan Krishna, Brighton (GB)

(21) Appl. No.: 18/591,997

(22) Filed: Feb. 29, 2024

(51) Int. Cl. H04W 28/22; H04W 72/0446

(52) U.S. Cl. CPC H04W 28/22; H04W 72/0446

(57) ABSTRACT

Methods, procedures, and apparatuses for distributed systems cross-layer optimization for extended reality (XR) applications are provided. For example, a method implemented by a wireless transmit/receive unit (WTRU) includes determining a first set of parameters associate with a decomposed task and a first transmission rate for transmitting packets to one or more neighboring nodes; transmitting a first set of packets to the one or more neighboring nodes using the first set of parameters and the first transmission rate; calculating a second transmission rate for transmitting packets to the one or more neighboring nodes; determining a second set of parameters associate with the decomposed task based on a triggering condition being met; and transmitting a second set of packets to the one or more neighboring nodes using the second set of parameters and the second transmission rate.

### BACKGROUND

In various implementations, an extended reality (XR) cloud gaming application runs on a devices such as a wireless transmit/receive unit (WTRU), and this XR application can be decomposed into multiple tasks, some of which may run on the WTRU and others on an Edge device. As such, new or enhanced distributed systems cross-layer optimization for XR applications may be desired.

### SUMMARY

This disclosure relates to communication networks, wireless and/or wired. For example, one or more embodiments disclosed herein are related to methods, procedures, architecture and apparatuses for cross-layer optimization to enable adaptation to volatile conditions in wireless communications. Methods, procedures, and architectures for distributed systems cross-layer optimization for extended reality (XR) applications are provided.

In one embodiment, methods, procedures, and components for distributed systems cross-layer optimization for XR applications are provided. For example, a method implemented by a wireless transmit/receive unit (WTRU) for wireless communications includes determining a first set of parameters associate with a decomposed task and a first transmission rate for transmitting packets to one or more neighboring nodes. The method also includes transmitting a first set of packets to the one or more neighboring nodes using the first set of parameters and the first transmission rate, and calculating a second transmission rate for transmitting packets to the one or more neighboring nodes. Additionally, the method includes determining a second set of parameters associate with the decomposed task based on a triggering condition being met, and transmitting a second set of packets to the one or more neighboring nodes using the second set of parameters and the second transmission rate.

In one embodiment, the WTRU comprising a processor, a transmitter, a receiver, and/or memory is configured to implement one or more methods disclosed herein. For example, the WTRU is configured to determine i) a first set of parameters associate with a decomposed task and ii) a first transmission rate for transmitting packets to one or more neighboring nodes; transmit a first set of packets to the one or more neighboring nodes using the first set of parameters and the first transmission rate; calculate a second transmission rate for transmitting packets to the one or more neighboring nodes; determine a second set of parameters associate with the decomposed task based on a triggering condition being met; and transmit a second set of packets to the one or more neighboring nodes using the second set of parameters and the second transmission rate.

In another embodiment, a proposed extension to the Session Description Protocol (SDP) (e.g., SDP in IETF) is provided. In an example, fields and data of one or more message exchanges discussed herein are mapped to SDP “Offer” procedure's capability negotiation parameters contained in the SIP protocol's UPDATE method.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of a distributed overlay network formed by multiple decomposed tasks of extended reality (XR) applications, according to one or more embodiments;

FIG. 3 is a diagram illustrating a software stack of a microservice node in an overlay network, according to one or more embodiments;

FIG. 4 is a diagram illustrating an example procedure of interaction of admission control at the upper layer and packet scheduling at the lower layer, according to one or more embodiments;

FIG. 5 is a diagram illustrating an example of flow conservation constraint for a target microservice node at a current microservice node, according to one or more embodiments;

FIG. 6 is a message sequence diagram illustrating an example of a cross-layer optimization procedure, according to one or more embodiments; and

FIG. 7 is a diagram illustrating an example of a packet structure having an encapsulated SDP message, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Communications Networks and Devices

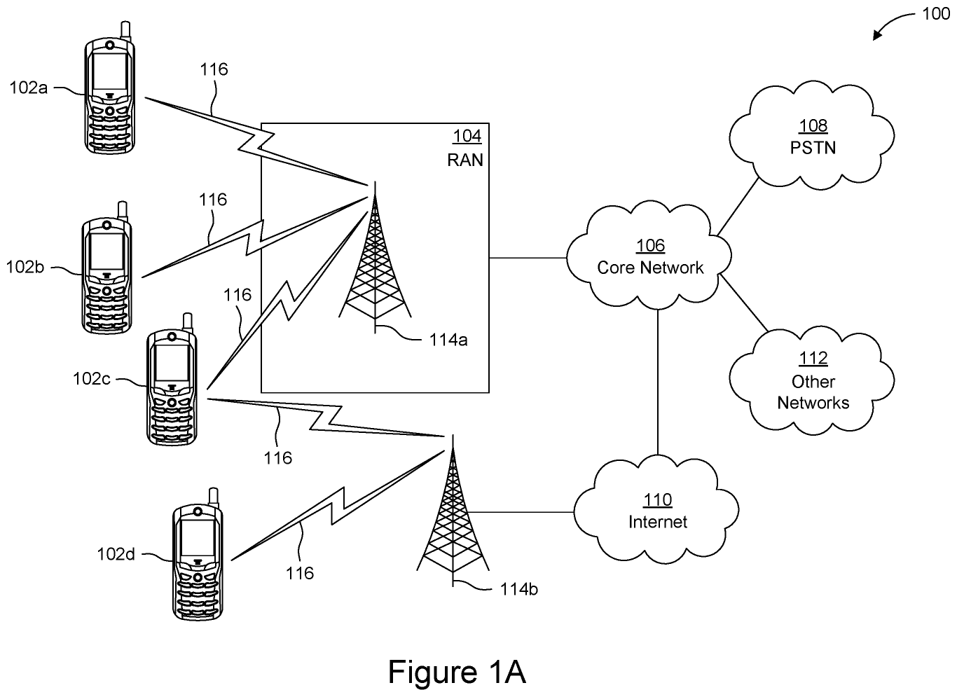

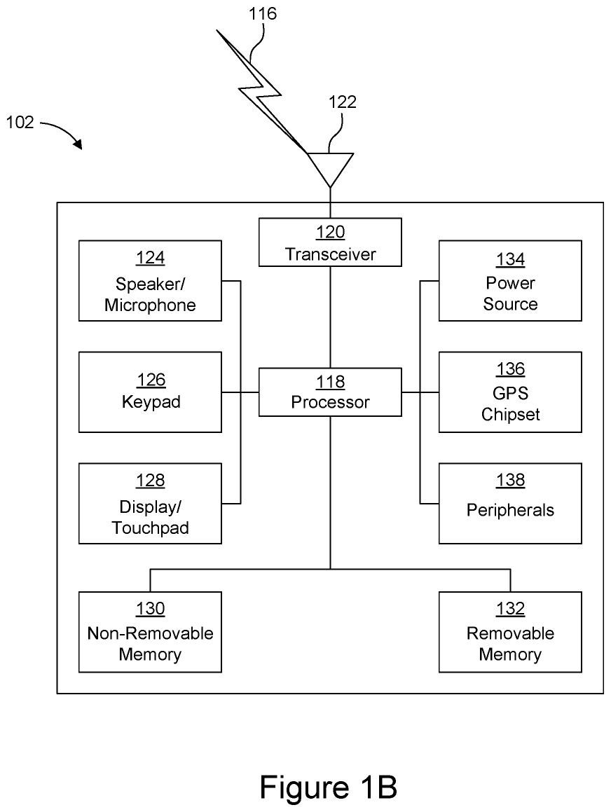

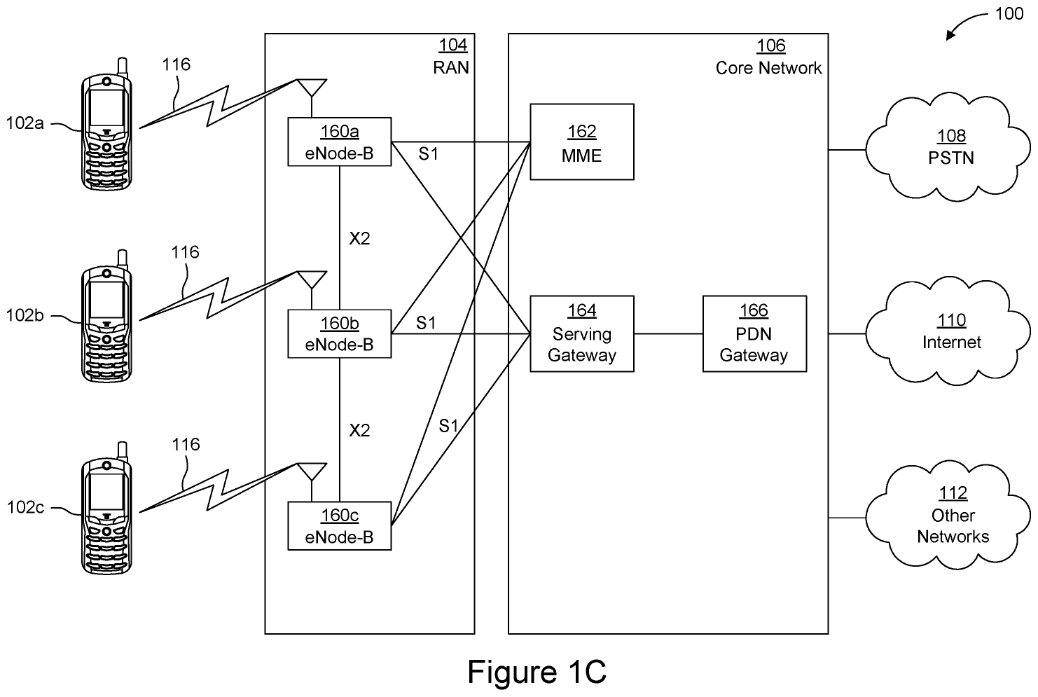

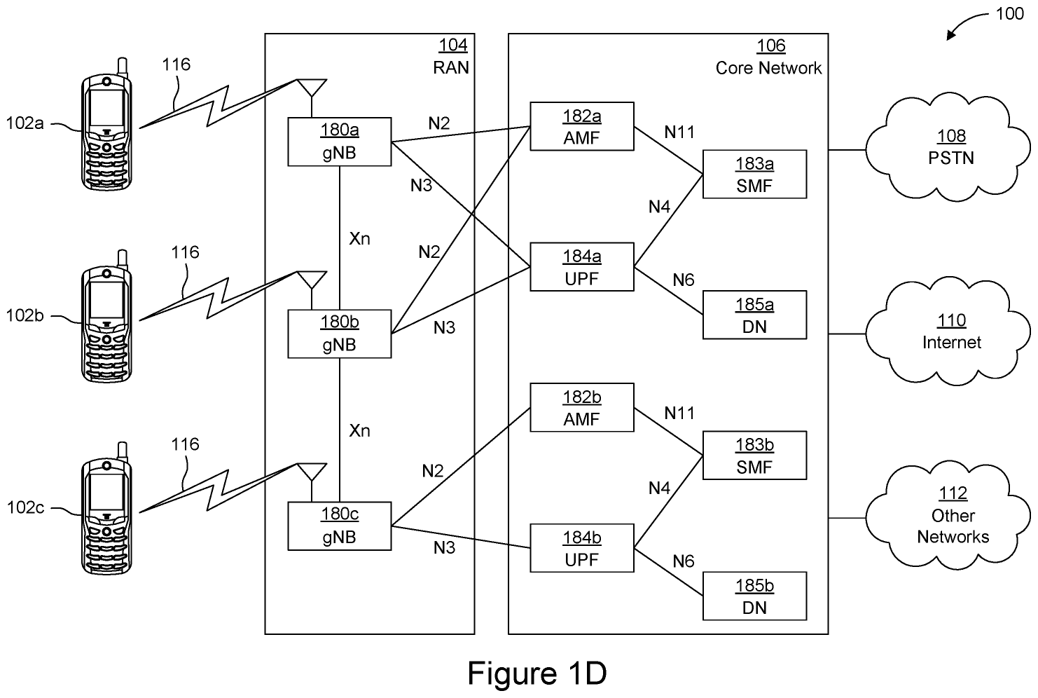

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

The current edge cloud infrastructure can be used to support Extended Reality (XR) applications. In some examples, an XR cloud gaming application may run on a WTRU (or a UE). This XR application may be decomposed into one or more tasks, some of which might run on the WTRU and others on an Edge device.

In an example, the user's actions in the game are captured by the “User Interaction” task and are sent as “User Commands” to a “Command Interpretation” task that receives the user commands from the client and converts them into “User Actions”. Next, the “User Actions” are interpreted as changes in the real world by the “AR/VR Logic” task. These world changes are then converted into “Rendered Scene” by the “GPU Rendering” task. The “GPU Rendering” task then forwards the “Rendered Scene” to a “Video Encoder” task which encodes (including compression) the video and sends that video to the “Video Streaming” task. Finally, the “Video Streaming” task sends the “Encoded Video” as a “Video Stream” to a “Video Decoder” task that then decodes the video and displays it on the WTRU (or UE) for the user.

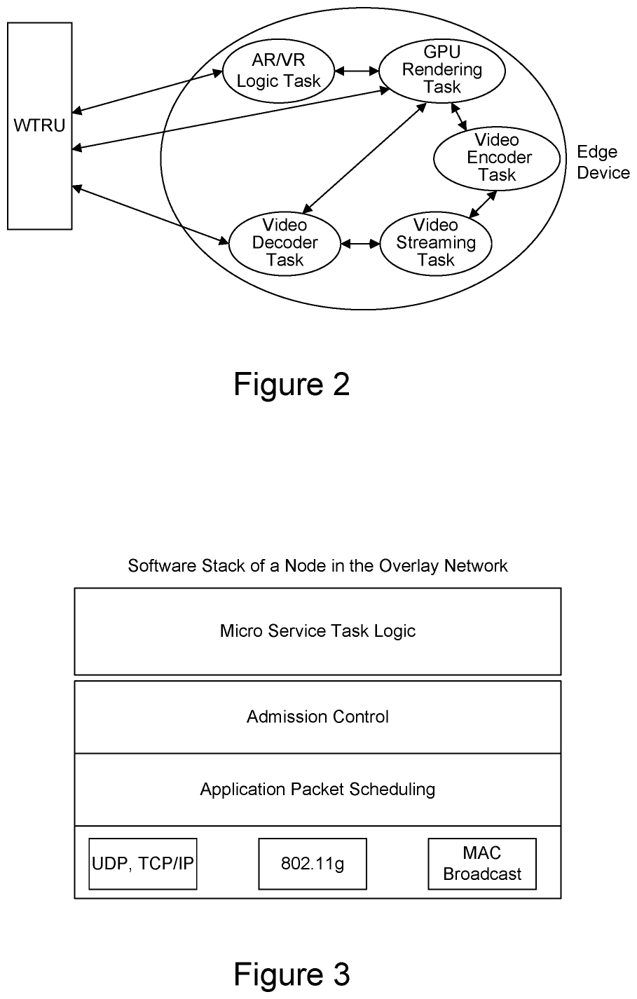

FIG. 2 illustrates an example of a distributed overlay network formed by the decomposed tasks of the XR application running on a WTRU (or a UE). As shown in FIG. 2, some of the decomposed tasks are running on the Edge cloud as microservices and form an overlay network with the WTRU. In an example, microservices are a type of services oriented architectural pattern where each microservice is deployed in a container and uses lightweight protocol such as REST or gRPC for communication.

These decomposed tasks include but are not limited to “AR/VR Logic” task, “GPU Rendering” task, Video Encoder” task, “Video Streaming” task, and/or “Video Decoder” task. In some examples, the “User Interaction” task and the “Command Interpretation” task are running on the WTRU. An overlay network is a virtual network including nodes and virtual links and sits on top of an underlying network. The overlay network represents a task dependency graph which captures the precedence constraints between various tasks and so is dependent on the implementation of the decomposition.

An overlay network comprises one or more microservices and can be tailored to meet the low-latency, high bandwidth needs of XR applications like the one discussed herein. For example, an overlay network with one or more microservices may have an upper layer of the overlay implement admission control and a lower layer of the overlay implement packet scheduling functionalities.

FIG. 3 illustrates an example of a software stack running underneath each microservice and the WTRU participating in the overlay network. In some cases, the lower layer itself can run over various inter-process services such as UDP, TCP/IP, or use services offered by a wireless network.

In an example, referring to FIG. 3, admission control is required to regulate in response to network conditions the amount of bandwidth that is available to the XR application running in the WTRU to communicate with the decomposed tasks running as microservices. Packet scheduling may be required to control the order in which the packets get transmitted and when they get dropped. Both admission control at the upper layer of the overlay network and the packet scheduling at the lower layer interact with each other to affect the quality-of-service parameters such as throughput and latency.

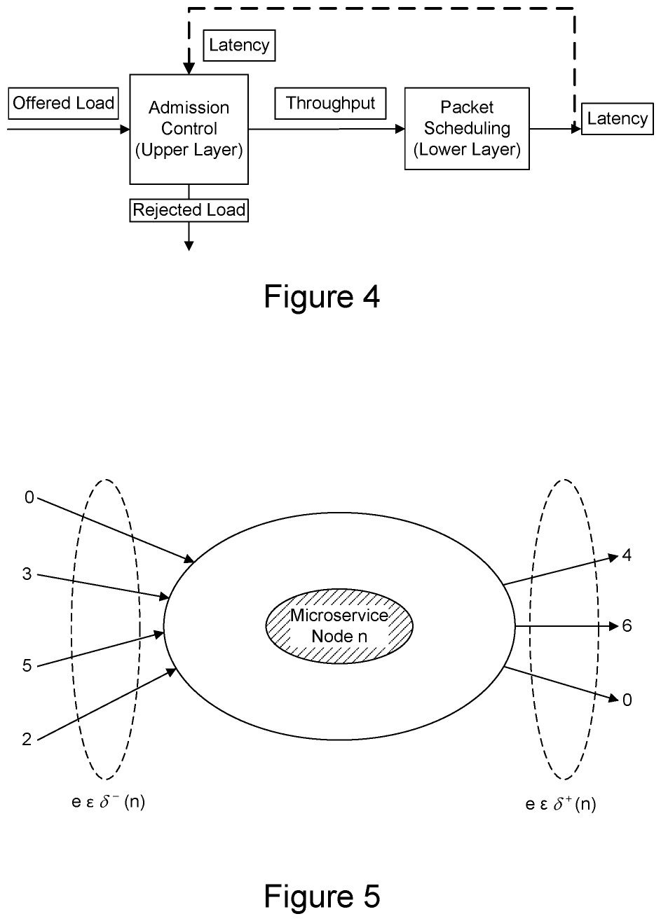

As shown in FIG. 4, when the offered traffic load is low as determined by the admission control, it will be accepted making it equal to the throughput. When that load is excessive as determined by the admission control, some of that traffic will be rejected. The packets of the traffic load that is accepted then suffer latency depending on the packet scheduling they experience at each node of the overlay. In addition, the packet scheduling also affects the throughput because the admission control can start rejecting the requested traffic load when the latency starts getting excessive.

Therefore, a cross-layer optimization algorithm may be desired to coordinate the two mechanisms of admission control at the upper layer and packet scheduling at the lower layer of the overlay of microservices.

In some implementations, a cross-layer optimization algorithm may coordinate the two mechanisms of admission control at the upper layer and packet scheduling at the lower layer of the overlay of microservices.

In an example, we represent the set of microservices by N and the set of links of the overlay network by E. Let uₑ represents the link capacities, t represent the target microservice where ∀t∈N. Each target microservice t is associated to a utility function Uₜ. Let hₙₜ represent the packets per second flow rate from a microservice n to target microservice t. The Network Utility Maximization (NUM) model for cross-layer optimizes the upper layer for admission control and lower layer for packet scheduling as follows:

$${max}_{x \geq 0 , h \geq 0} \sum {U}_{t} ( {h}_{nt} ) subject to : \qquad ( 1 )$$

$${q}_{nt} : {\sum }_{e ∈ {δ}^{+} ( n )} {x}_{te} - {\sum }_{e ∈ {δ}^{-} ( n )} {x}_{te} \{ \begin{matrix}\geq & {h}_{nt} if n \neq t \\ \geq & 0 , otherwise\end{matrix} , ∀ t ∈ N , n ∈ N - t \qquad ( 2 )$$

$${\sum }_{t} {x}_{te} \leq {u}_{e} , ∀ e ∈ E \qquad ( 3 )$$

The objective function of equation (1) seeks to maximize network utility which represents the XR application performance at the upper layer of the overlay.

Equation (2) represents the flow conservation constraints. One conservation constraint is applicable for each microservice n and each target t. This conservation constraint states that when a microservice is not the destination of traffic, the difference between the packets that get in and those that get out is at least as great as the amount hₙₜ of traffic that the microservice n generates to microservice t.

Referring to FIG. 5, the expression e∈δ⁻(n) represents the set of edges that are incoming to microservice node n and e∈δ⁺(n) represents the set of edges that are outgoing to the microservice node n. The decision variable xₜₑ represents the amount of traffic targeted to microservice t that traverses the link e and is less than or equal to the link capacity uₑ.

Equation (3) is the link capacity constraint and states that Xₜₑ the amount of traffic targeted to microservice t that traverses the link e is less than or equal to the link capacity uₑ.

Applying a dual approach by relaxing the decision variables hₙₜ and using multipliers qₙₜ, we can separate the problem into two expressions:

$${max}_{x \geq 0 , {\sum }_{t} {x}_{te} \leq {u}_{e}} {\sum }_{te} {x}_{te} ( {q}_{b ( e ) t} - {q}_{a ( e ) t} ) \qquad ( 4 )$$

$${max}_{h \geq 0} {\sum }_{t} {U}_{t} ( {h}_{nt} ) - {q}_{a ( e ) t} {h}_{nt} \qquad ( 5 )$$

The multiplier qₙₜ is proportional to the queue length of packets from source microservice n to target microservice t.

$${q}_{nt} = γ {Q}_{nt} \qquad ( 6 )$$

The quantity q_{b(e)t} in equation (4) can be interpreted as the pressure felt by the origin microservice of link e to transmit traffic addressed to microservice t. Similarly, the quantity qₐ₍ₑ₎ₜ in equations (4) and (5) can be interpreted as the pressure felt by the destination microservice of link e to transmit traffic addressed to microservice t.

Equation (4) is the first subproblem that determines the packet scheduling in the lower layer of the overlay formed by the microservices. This is done by solving each subproblem independently for each link e. Assuming that the quantity (q_{b(e)t}−qₐ₍ₑ₎ₜ)) is negative, the link e forwards traffic to destination microservice t for which (q_{b(e)t}−qₐ₍ₑ₎ₜ) is minimum. If (q_{b(e)t}−qₐ₍ₑ₎ₜ)>0 for all traffic, no traffic is forwarded by the link. To make the forwarding decision each microservice n only needs to know the q_{n′d} multipliers for all destinations t in the neighboring microservice nodes n′.

The second subproblem is captured by equation (5). This equation can be solved independently for traffic to each target microservice t by using local information qₐ₍ₑ₎ₜ at the source microservice for the edge e. An α- utility function is used for Uₜ. The parameter αis a non-negative number representing fairness in packet scheduling:

$${h}_{nt} = {q}_{a ( e ) t}^{- 1 / α} , ∀ t ∈ N \qquad ( 7 )$$

The two layers of the overlay formed by the microservice can coordinate the admission control at the upper layer and packet scheduling at the lower layer as follows: The packet scheduling lower layer requires that each microservice is sent the q_{n′t} values for all target microservices t from all outgoing neighboring microservices. Then each target microservice t needs the multiplier qₙₜ for the origin microservice n=a(e)t which is just local information. The multipliers qₙₜ update using gradient iteration with t′ representing time as follows:

$${q}_{nt} ( {t}^{′} + 1 ) = {[ {q}_{nt} ( {t}^{′} ) + γ ( {h}_{nt} - {\sum }_{e {ϵδ}^{+} ( n )} {x}_{te} ( {t}^{′} ) + {\sum }_{e {ϵδ}^{-} ( n )} {x}_{te} ( {t}^{′} ) ) ]}_{0} \qquad ( 8 )$$

As discussed, hₙₜ represents the packets per second flow rate from a microservice n to target microservice t. The multiplier qₙₜ has a sub-gradient coordinate that is the difference between the new traffic in the microservice n that needs to be transmitted to the microservice t and the already transmitted traffic. As a result, for a constant step γ, qₙₜ is proportional to queue size Qₙₜ of traffic to microservice t that is pending at microservice n.

$${q}_{nt} = γ {Q}_{nt} , ∀ n ∈ N , t ∈ N \qquad ( 9 )$$

In an implementation, an algorithm to implement the above discussion is as follows:

Microservice node's algorithm: for times t=t₁(n), t₂(n), . . . microservice n:
a) Microservice collects the information about the length of its queues {qₙₜ, ∀t}.
b) Signal it to incoming neighbor microservices.

Microservices' overlay link algorithm for times t′=t₁′(e), t₂′(e), . . . microservice link e:
a) Collects from outgoing neighbors the updated qₙₜ values.
b) Transmit the traffic to that destination microservice t which is greater than zero and has the highest pressure difference.

Algorithm for admission control at the WTRU:
a) Admit only transmission rates of hₙₜ calculated using equation (7).

### Overview

As player of the game moves around in physical space, their WTRU (e.g., XR device) experiences volatile conditions. These may include: 1) the devices and communication links might fail; 2) the communication links may face variable latency and bandwidth; and/or 3) the logical association between software components might be created and destroyed.

As discussed, the XR system such as a game running on a WTRU will have decomposed tasks running on the edge as microservices. Because of volatility, the WTRU can face wireless disconnections resulting in poor Quality of Experience (QoE) for the game player. This wireless dis-connectivity can have multiple reasons. The WTRU might move beyond their operating distance causing a disconnection. The WTRU may face radio occlusion because of buildings, people moving around etc.

In addition, under volatile conditions, the WTRU running the XR system such as a game can face fluctuating bandwidth and latency. This is because of error rates that are induced by the same factors as wireless disconnections. With more error rates, more packets are dropped leading to low throughput and available bandwidth.

As the game player with the WTRU moves around, the logical association between the software components on it and the microservices running on the edge may change. This could happen for example when a microservice is physically closer to the user than a similar microservice currently associated to the WTRU and as a result, the WTRU is switched to the microservice that is closer to it.

Thus, overall, the WTRU running the XR system such as a game might have multiple states of connection to the edge server hosting the decomposed tasks as microservices. It might have strong connectivity, weak connectivity or dis-connectivity with the edge.

In some examples, the WTRU and the microservices may form an overlay network that can have its own admission control and scheduling of packets that are tunneled through the lower layer.

Any cross-layer protocol that handles admission control at the upper layer and scheduling at the lower layer will suffer from the volatile conditions described above. In particular, the protocol parameters might be delayed or lost in such conditions. This will cause the protocol to run with stale parameters which will delay its convergence to stable outputs or to converge to sub-optimal outputs for admission control at the upper layer and scheduling at the lower layer. This paper therefore seeks to solve the following problem:

As such, it is desired to provide timely computation results for admission control at the upper layer and scheduling at the lower layer to a set of decomposed tasks running as microservices in volatile conditions.

### Representative Procedure for Cross-Layer Optimization for XR Applications

In one embodiment, an example procedure is provided that adapts an algorithm that a WTRU running an XR application and being connected to decomposed tasks. One or more of the decomposed tasks are running as microservices. In an aspect, the example procedure may deal with the problem of volatility as discussed above.

In an example, the proposed procedure includes cross-layer optimization algorithms that can be used in the overlay network of microservices by exchanging novel parameters under volatile conditions. In an example, a disconnected or a weak connectivity state of the WTRU (e.g., as a result of volatility) may be captured by the proposed communication procedure between the WTRU and the microservices. In an example, the proposed procedure supports speculation techniques (e.g., prediction) to deal with the disconnected or weak connectivity state. In various examples, the proposed procedure using a cross-layer optimization algorithm that enables admission control at the upper layer and packet scheduling at the lower layer can function even under volatile conditions.

As discussed above, the WTRU running the XR application might have strong connectivity, weak connectivity or dis-connectivity with the Edge. In various embodiments discussed herein, a state Hoarding is associated with strong connectivity. In this Hoarding state, the WTRU aggressively accumulates qₙₜ parameters to ensure that an accurate model for predicting these values is maintained. On the other hand, a dis-connected/weak connectivity state is associated with weak connectivity and/or dis-connectivity. In this latter state, the model constructed for qₙₜ values is utilized to opportunistically predict future values. In some cases, a mechanism for prediction (such as Exponentially Weighted Moving Average or a Distributed Neural Network (DNN)) is running on each respective microservice node.

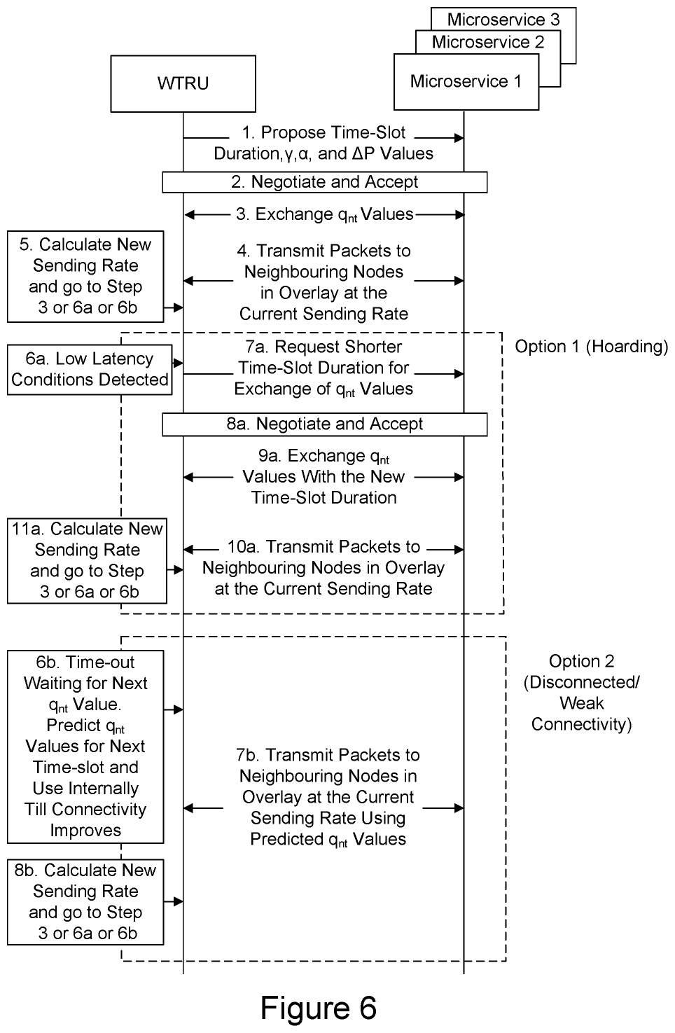

Referring to FIG. 6, a message sequence diagram is provided to illustrate an example of the proposed procedure, which includes one or more of the following operations or steps.

Operation 1: As an initialization operation/step, the WTRU proposes to each of the decomposed task running as a microservice on the edge the time-slot duration, γ, α, and ΔP values to run the optimization algorithm in a distributed fashion. In practical situations, example values could be:

γ=0.1, α=2, and ΔP=1.

In an example, the sending rate for each link in the overlay topology could for example be initialized to be equal to half of the total capacity of the link.

Operation 2: The WTRU negotiates the values of the parameters with each of the microservice to which it is connected in the overlay and a globally common value is accepted.

Operation 3: The WTRU collects the qₙₜ queue lengths for its queues and signals it to the microservices to which it is connected in the overlay. Similarly, the microservices running on the edge server send their queue lengths that is their respective values of qₙₜ to the WTRU if they are connected to it in the overlay.

Operation 4: The admission control functional module on the nodes transmits packets to neighbouring nodes in overlay topology at the current sending rate using equation (4). This is done by solving each subproblem independently for each link e. Assuming that the quantity (q_{b(e)t}−qₐ₍ₑ₎ₜ) is negative, the link e forwards traffic to destination microservice t for which (q_{b(e)t}−qₐ₍ₑ₎ₜ) is minimum. If (q_{b(e)t}−qₐ₍ₑ₎ₜ))>0 for all traffic, no traffic is forwarded by the link.

Operation 5: The WTRU uses equation (7) to calculate a new value of the sending rate. This new value now becomes the current sending rate. After this operation, the procedure has a choice of three options. i) The procedure returns to operation 3 if either the hoarding state or the disconnected/weak connectivity state as explained above at the WTRU is not reached. This decision can be made for example using threshold values of observed latency. ii) The procedure goes to operation 6a if the hoarding state is reached at the WTRU. iii) The procedure goes to operation 6b if the disconnected/weak connectivity state because of timeout is reached at the WTRU.

Operation 6a: As discussed above, this operation is executed if the hoarding state is reached at the WTRU. This happens when low latency conditions are detected. The WTRU takes advantage of this state by hoarding qₙₜ values for its incoming links from the microservices. This is done by exchanging these values in shorter time slots in the next operations 7a and 8a.

Operation 7a: The WTRU requests shorter time-slot duration for the exchange of qₙₜ values from all the microservices to which it has a direct link in the overlay topology. This is done to take advantage of low latency to hoard as many qₙₜ as possible. When the connectivity is weak, or we have disconnection, these values can be used to predict qₙₜ values accurately.

Operation 8a: The WTRU and the microservices to which it has a direct link in the overlay topology negotiate and agree to a new value for the time-slot duration.

Operation 9a: The WTRU collects the qₙₜ queue lengths for its queues and signals it to the microservices to which it is connected in the overlay. Similarly, the microservices running on the edge server send their queue lengths that is their respective values of qₙₜ to the WTRU if they are connected to it in the overlay.

Operation 10a: The admission control functional module on the nodes transmits packets to neighbouring nodes in overlay topology at the current sending rate using equation (4). This is done by solving each subproblem independently for each link e. Assuming that the quantity (q_{b(e)t}−qₐ₍ₑ₎ₜ) is negative, the link e forwards traffic to destination microservice t for which (q_{b(e)t}−qₐ₍ₑ₎ₜ)) is minimum. If (q_{b(e)t}−qₐ₍ₑ₎ₜ)>0 for all traffic, no traffic is forwarded by the link.

Operation 11a: The WTRU uses equation (7) to calculate a new value of the sending rate. This new value now becomes the current sending rate. After this operation, the procedure has a choice of three options. i) The procedure returns to operation 3 if either the hoarding state or the Disconnected/Weak Connectivity state as explained above at the WTRU is not reached. This decision can be made for example using threshold values of observed latency. ii) The procedure goes to operation 6a if the hoarding state is reached at the WTRU. iii) The procedure goes to operation 6b if the Disconnected/Weak Connectivity state is reached at the WTRU.

In this example, still referring to FIG. 6, the proposed procedure may move to operation 6b based on a detected disconnected/weak connectivity state and/or the WTRU times out waiting for a qₙₜ value from a microservice linked to it on the overlay topology.

Operation 6b: This operation is triggered when the WTRU times out waiting for a qₙₜ value from a microservice linked to it on the overlay topology. This is interpreted at the WTRU as the Disconnected/Weak Connectivity state.

Operation 7b: The admission control functional module on the nodes opportunistically transmits packets to neighbouring nodes in overlay topology at the current sending rate using equation (4). This is done by solving each subproblem independently for each link e. Note that the q_{b(e)t} value (labelled qₙₜ in the figure) is a predicted value in this operation. We assume that a prediction module (e.g. Exponentially Weighted Moving Average, or Deep Neural Network) is running on each node. Assuming that the quantity (q_{b(e)t}−qₐ₍ₑ₎ₜ)) is negative, the link e forwards traffic to destination microservice t for which (q_{b(e)t}−qₐ₍ₑ₎ₜ) is minimum. If (q_{b(e)t}−qₐ₍ₑ₎ₜ₎>0 for all traffic, no traffic is forwarded by the link.

Operation 8b: The WTRU uses equation (7) to calculate a new value of the sending rate. This new value now becomes the current sending rate. After this operation, the procedure has a choice of three options. i) The procedure returns to operation 3 if either the hoarding state or the Disconnected/Weak Connectivity state as explained above at the WTRU is not reached. This decision can be made for example using threshold values of observed latency. ii) The procedure goes to operation 6a if the hoarding state is reached at the WTRU. iii) The procedure goes to operation 6b if the Disconnected/Weak Connectivity state is reached at the WTRU.

### Representative Procedure for Extension to Session Description Protocol (SDP)

In one embodiment, a proposed extension to the Session Description Protocol (SDP) (e.g., SDP in IETF) is provided. In an example, fields and data of one or more message exchanges illustrated in FIG. 6 may be mapped to an SDP “Offer” procedure's capability negotiation parameters contained in the SIP protocol's UPDATE method.

In an example, to add new capabilities to SDP, a new attribute type “a=” at the session level may be defined. Attributes at the session level are listed before the first media line in SDP. The following shows a set of proposed new SDP offer procedure's capability attribute.

For example, the message for Operation 1 in FIG. 6 may be sent as a new SDP offer procedure's capability attribute: “a=cross_layer_params: parameter1 parameter2 . . . parameter”. Here “a=cross_layer_params: ” is the new attribute representing the parameters separated by space required for cross-layer optimization. Therefore parameter 1 for Operation 1 is the time slot duration, parameter 2 is γ which represents the step size of the cross layer algorithm. Parameter 3 is a which is a non-negative number representing fairness for scheduling, and the last parameter is ΔP which represents the threshold for pressure difference.

In another example, the message for Operation 3 in FIG. 6 may be sent as a new SDP offer procedure's capability attribute: “a=queue_param: parameter1 parameter2 . . . parameter”. Here “a=queue_param: ” is the new attribute representing the parameter required to exchange data about the queues. For example, in Operations 3, 7a, 9a, 7b in FIG. 6, there is a single parameter qₙₜ which represents the length of the queue on the microservice.

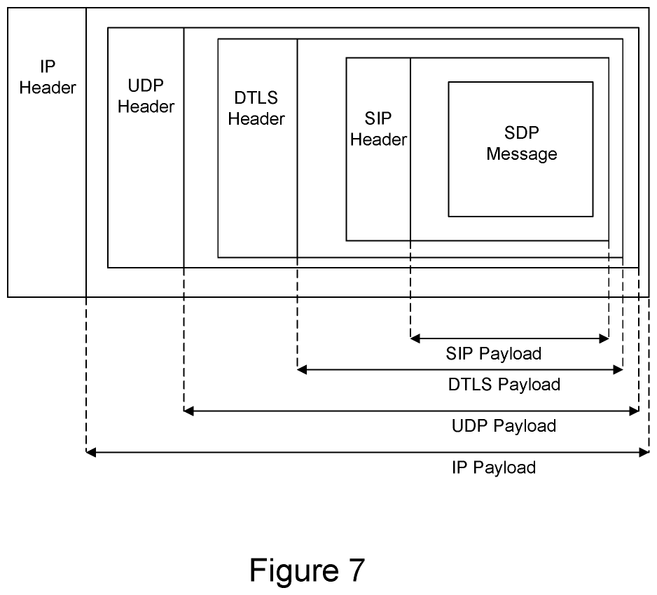

In an example, referring to FIG. 7, a packet structure of an encapsulated SDP message is provided. As shown in FIG. 7, the resultant packet structure includes the proposed extension to SDP with UDP as an example transport.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method implemented by a wireless transmit/receive unit (WTRU) for wireless communications, the method comprising:
determining i) a first set of parameters associate with a decomposed task and ii) a first transmission rate for transmitting packets to one or more neighboring nodes;
transmitting a first set of packets to the one or more neighboring nodes using the first set of parameters and the first transmission rate;
calculating a second transmission rate for transmitting packets to the one or more neighboring nodes;
determining a second set of parameters associate with the decomposed task based on a triggering condition being met; and
transmitting a second set of packets to the one or more neighboring nodes using the second set of parameters and the second transmission rate.

2. The method of claim 1, wherein the triggering condition comprises any of: detecting a low latency condition at the WTRU; detecting a hoarding state at the WTRU; detecting a disconnected state at the WTRU; detecting a weak connectivity state at the WTRU; or a detected latency being above a threshold value.

3. The method of claim 1, wherein the decomposed task runs as a microservice on an Edge device associated with the WTRU.

4. The method of claim 3, further comprising:
determining a set of queue lengths based on the triggering condition being not met, and
transmitting the set of queue lengths to the microservice, wherein the microservice is connected in an overlay.

5. The method of claim 4, wherein the triggering condition being not met comprises any of a hoarding state, a disconnected state, or a weak connectivity state at the WTRU being not detected or reached.

6. The method of claim 1, wherein the triggering condition being met comprises detecting a low latency condition or a hoarding state at the WTRU, and wherein the second set of packets are transmitted in a shorter time slot duration than transmitting the first set of packets.

7. The method of claim 1, wherein the triggering condition being met comprises a set of queue lengths from a microservice being not received after a pre-configured time period.

8. The method of claim 1, further comprising receiving a session description protocol (SDP) message indicating the first set of parameters.

9. The method of claim 1, wherein the first set of packets or the second set of packets is associated with a session description protocol (SDP) message.

10. A wireless transmit/receive unit (WTRU) for wireless communications, comprising circuitry, including a transmitter, a receiver, a processor and memory, the WTRU configured to:
determine i) a first set of parameters associate with a decomposed task and ii) a first transmission rate for transmitting packets to one or more neighboring nodes;
transmit a first set of packets to the one or more neighboring nodes using the first set of parameters and the first transmission rate;
calculate a second transmission rate for transmitting packets to the one or more neighboring nodes;
determine a second set of parameters associate with the decomposed task based on a triggering condition being met; and
transmit a second set of packets to the one or more neighboring nodes using the second set of parameters and the second transmission rate.

11. The WTRU of claim 10, wherein the triggering condition comprises any of: detecting a low latency condition at the WTRU; detecting a hoarding state at the WTRU; detecting a disconnected state at the WTRU;
detecting a weak connectivity state at the WTRU; or a detected latency being above a threshold value.

12. The WTRU of claim 10, wherein the decomposed task runs as a microservice on an Edge device associated with the WTRU.

13. The WTRU of claim 12, wherein the WTRU is further configured to:
determine a set of queue lengths based on the triggering condition being not met, and
transmit the set of queue lengths to the microservice, wherein the microservice is connected in an overlay.

14. The WTRU of claim 13, wherein the triggering condition being not met comprises any of a hoarding state, a disconnected state, or a weak connectivity state at the WTRU being not detected or reached.

15. The WTRU of claim 10, wherein the triggering condition being met comprises detecting a low latency condition or a hoarding state at the WTRU, and wherein the second set of packets are transmitted in a shorter time slot duration than transmitting the first set of packets.

16. The WTRU of claim 10, wherein the triggering condition being met comprises a set of queue lengths from a microservice being not received after a pre-configured time period.

17. The WTRU of claim 10, wherein the WTRU is further configured to receive a session description protocol (SDP) message indicating the first set of parameters.

18. The WTRU of claim 10, wherein the first set of packets or the second set of packets is associated with a session description protocol (SDP) message.
